(19) United States
(12) Patent Application Publication
(10) Pub. No.: US 2024/0102894 A1
(43) Pub. Date: Mar. 28, 2024

(54) DEVELOPMENT AND EVALUATION OF A HIGH-VOLUME CASCADE IMPACTOR FOR THE COLLECTION OF FINE AND ULTRAFINE PARTICULATE MATTER ON GELATIN FILTER SUBSTRATES

(71) Applicant: UNIVERSITY OF SOUTHERN CALIFORNIA, Los Angeles, CA (US)

(72) Inventor: Constantinos SIOUTAS, Pasadena, CA (US)

(21) Appl. No.: 18/367,640

(22) Filed: Sep. 13, 2023

Related U.S. Application Data
(60) Provisional application No. 63/406,090, filed on Sep. 13, 2022.
(60) Provisional application No. 63/408,568, filed on Sep. 21, 2022.

(51) Int. Cl. G01N 1/22

(52) U.S. Cl. CPC G01N 1/2208

(57) ABSTRACT

A gelation cascade impactor includes a first impaction stage in fluid communication with ambient air. The first impaction stage includes a first slit and a first impaction substrate onto which air impacts such that particles within a first particle size range are collected. The gelation cascade impactor also includes a second impaction stage in fluid communication with the first impaction stage. The second impaction stage includes one or more second slits and a second impaction substrate onto which air impacts such that particles within a second particle size range are collected. Characteristically, the area of the first slit is greater than the total area of the one or more second slits such that the first particle size range is greater than the second particle size range. The gelation cascade impactor also includes a pump in fluid communication with the first impaction stage and second impaction stage.

### CROSS-REFERENCE TO RELATED APPLICATIONS

This application claims the benefit of U.S. provisional application Ser. No. 63/406,090 filed Sep. 13, 2022, and U.S. provisional application Ser. No. 63/408,568 filed Sep. 21, 2022, the disclosures of which are hereby incorporated in their entirety by reference herein.

### TECHNICAL FIELD

In at least one aspect, the present invention is related to the collection of aerosol particles.

### BACKGROUND

The collection of ambient aerosols with different particle sizes is accomplished by various technologies, including inertial impactors and aerosol concentrators. Although aerosol concentrators have been widely used for the collection of ambient PM, employing inertial impactors that are operated at a high flow rate leads to a simpler setup and lower cost (Kavouras et al., 2000).

Previous publications used inertial impactors to collect ambient particles on various types of substrates, including PTFE (Teflon™)) and quartz filters (Biswas & Gupta, 2017). The efficiency of extracting the collected particles in Milli-Q water is often much lower than 100% due to the insolubility of some particles, making it difficult to extract all the collected particles in the sample (Huang et al., 2020).

Accordingly, there is a need for improved impactors for the collection of ambient particles.

### SUMMARY

In at least one aspect, a high-volume gelation cascade impactor (GCI) for the collection of different ambient PM fractions on water-soluble gelatin substrates for further use in toxicological studies is provided.

In another aspect, a gelation cascade impactor system that includes a gelation cascade impactor is provided. The gelation cascade impactor includes a first impaction stage in fluid communication with ambient air. The first impaction stage includes a first slit and a first impaction substrate onto which air impact such that particles within a first particle size range are collected. The gelation cascade impactor also includes a second impaction stage in fluid communication with the first impaction stage. The second impaction stage includes one or more second slits and a second impaction substrate onto which air impacts such that particles within a second particle size range are collected. Characteristically, the area of the first slit is greater than the total area of the one or more second slits such that the first particle size range is greater than the second particle size range. The gelation cascade impactor also includes a pump in fluid communication with the first impaction stage and second impaction stage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1A provides a schematic of the two impaction stages.

FIG. 1B provides a schematic of the gelatin cascade impactor.

FIG. 2. Experimental setup schematic for the laboratory characterization of the gelatin cascade impactor.

FIG. 3. Pressure drop as a function of GCI flow rate for stages 1 and 2.

FIGS. 4A and 4B. Collection efficiency curves of the GCI (A) first impaction stage and (B) second impaction stage using gelatin filters and various artificially generated aerosols. X-axis represents optical diameters for particles ≥0.3 μm and mobility diameters for particles <0.3 μm. Error bars are standard deviations.

FIGS. 5A and 5B. Collection efficiency curves of the GCI (A) first impaction stage and (B) second impaction stage using quartz filters and various artificially generated aerosols. X-axis represents optical diameters for particles ≥0.3 μm and mobility diameters for particles <0.3 μm. Error bars are standard deviations.

FIGS. 6A and 6B. The comparison of mass concentrations of collected particles using PCIS and GCI (A) first and (B) second impaction stages. Error bars are standard deviations.

FIGS. 7A and 7B. Inorganic ion (A) blank levels in gelatin substrate and (B) the normalized concentrations (per volume of air based on 24 h sampling) of the blank gelatin in comparison with typical ambient PM levels in Los Angeles. Error bars are standard deviations.

FIGS. 8A and 8B. Metals and trace elements (a) blank levels in gelatin substrate in comparison with PTFE and (b) the normalized concentrations (per volume of air based on 24 h sampling) of the blank gelatin in comparison with typical ambient PM levels in Los Angeles. Error bars are standard deviations.

FIG. 9. DTT activity comparison between the blank gelatin substrate and PM collections in three major cities around the world. Error bars are standard deviations.

FIGS. 10A and 10B. Particle number concentrations as a function of particle diameter for (A) gelatin and (B) UFP suspensions. X-axis represents mobility diameters measured by SMPS. Error bars are standard deviations.

FIG. 11. Ambient PM2.5 mass concentrations based on the GCI and PCIS. The error bars are standard deviations.

FIGS. 12A and 12B. Redox activity of particles collected on gelatin filter using the GCI in comparison with particles collected on PTFE using the PCIS based on (A) DTT and (B) ROS assays. Error bars are standard deviations.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The phrase “composed of” means “including” or “comprising.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

Throughout this application, where publications are referenced, the disclosures of these publications in their entireties are hereby incorporated by reference into this application to more fully describe the state of the art to which this invention pertains.

### Abbreviations

“CGI” means gelatin cascade impactor.
“OPS” means optical particle sizer.
“PCIS” means Personal Cascade Impactor Sampler.
“PM” means particulate matter.
“SMPS” means scanning mobility particle sizer.

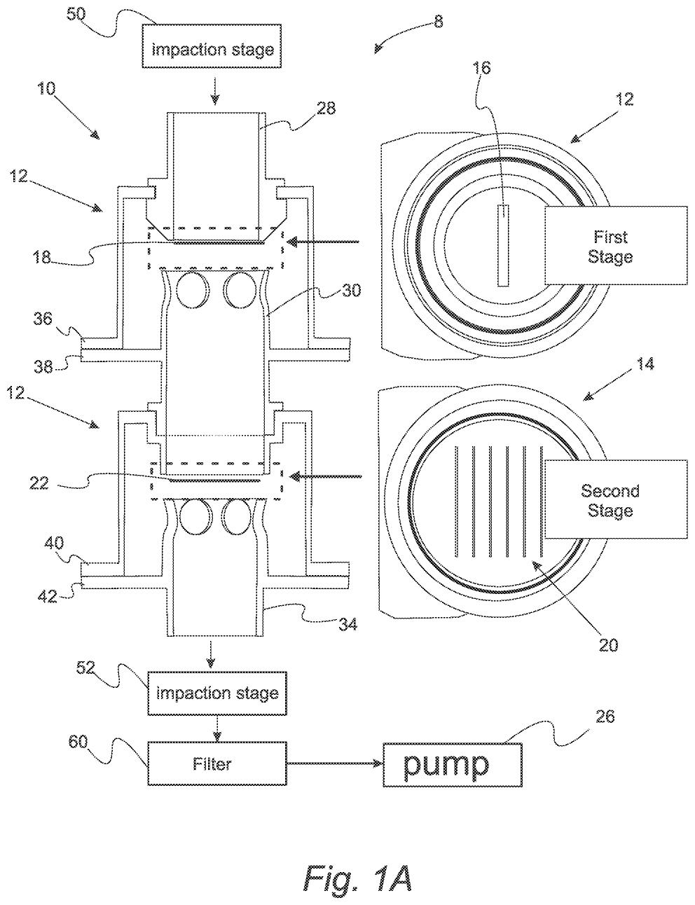

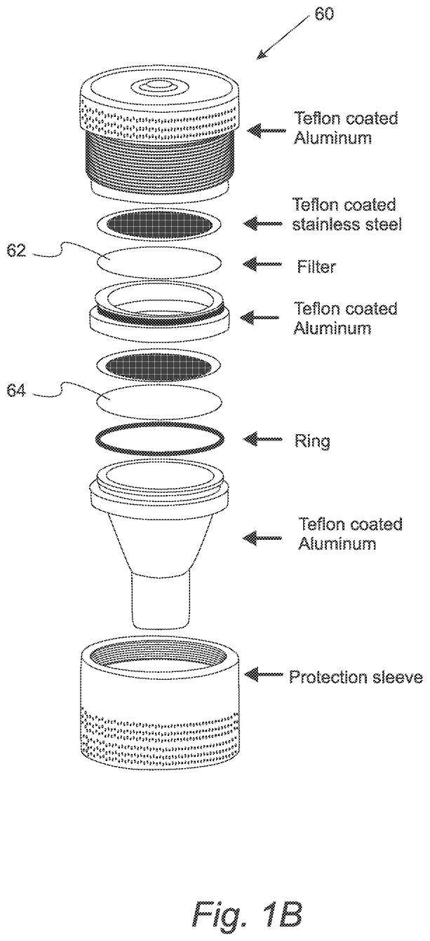

With reference to FIG. 1A, a schematic of a gelation cascade impactor with at least two impaction stages is provided. Gelation cascade impactor system 8 includes gelation cascade impactor 10. Gelation cascade impactor 10 includes first impaction stage 12 and second impaction stage 14. First impaction stage 12 is in fluid communication with ambient air while second impaction stage 14 is in fluid communication with and downstream of first impaction stage 12. First impaction stage 12 includes a first slit 16 and a first impaction substrate 18 onto which air impact such that particles within a first particle size range are collected. Similarly, second impaction stage 14 includes one or more second slits 20 and a second impaction substrate 22 onto which air impact such that particles within a second particle size range are collected. In a refinement, first impaction substrate 18 and second impaction substrate 22 are composed of a material that is soluble in water (i.e., a water-soluble material) thereby allowing analysis of collected particles. In a further refinement, first impaction substrate 18 substrate and second impaction substrate 22 are composed of gelatin. Characteristically, the area of the first slit 16 is greater than the total area of the one or more second slits 20. Alternatively expressed, the first impaction stage has a cut-point diameter greater than that of the second impaction stage. In this context, cut-point diameter is the diameter or size of the smallest particle to be collected by a specific impaction stage. Therefore, the average particle size collected by the first impaction substrate 18 is greater than the average particle size collected by the second impaction substrate 22. Gelation cascade impactor system 10 also includes a pump 26 that draws ambient air through the includes first impaction stage 12 and second impaction stage 14.

Referring to FIG. 1A, gelation cascade impactor 10 includes first conduit section 28 that guides a gas (e.g., air) to first slit 16. After passing through first slit 16, the gas impact first impaction substrate 18. The gas than proceeds through second conduit section 30 to second slit 20. The gas can enter second conduit section 30 through access openings 32. After impacting second impaction substrate 22, the gas flows through exit conduit section 34 which includes access openings 36 that allow gas to flow into exit conduit section 34. First conduit section 28 can be attached to second conduit section 30 via a flanged connection defined by flange section 36 attached to first conduit section 28 mated to flange section 38 attached to second conduit section 30. Similarly, second conduit section 30 can be attached to exit conduit section 34 via a flanged connection defined by flange section 40 attached to second conduit section 30 mated to flange section 42 attached to exit conduit section 34. First conduit section 28, second conduit section 30, exit conduit section 34, flange section 36, flange section 38, flange section 40, and exit conduit section 34 can be fabricated from any suitably rigid material such as a metal (e.g., stainless steel) or a rigid plastic.

In another aspect, the area of the first slit 16 is 2 to 8 times greater than the total area of the one or more second slits 20. In some refinements, the area of the first slit 16 is at least 2, 3, 4, or 5 times greater than the total area of the one or more second slits 20. In further refinements, the area of the first slit 16 is at most 10, 8, 7, or 6 times greater than the total area of the one or more second slits 20.

In another aspect, the first impaction stage has a cut-point diameter from about 1.5 μm to 5 μm and the second impaction stage has a cut-point diameter from about from about 0.1 to 0.5 m. In some refinements, the first impaction stage has a cut-point diameter of at least 1 μm, 1.5 μm, 2 μm, or 2.5 μm, and at most, 7 μm, 6 μm, 5 μm, or 4 μm. In some refinements, the second impaction stage has a cut-point diameter of at least 0.5 μm, 0.1 μm, 0.15 μm, or 0.2 μm, and at most, 0.8 μm, 0.7 μm, 0.6 μm, or 0.5 μm.

The physical characteristics of the first impaction substrate 18 and the second impaction substrate 22 are achieved by employing the following Stokes equation for designing the cut-point diameter and nozzle dimensions of the impactor:

$${St}_{50} = \frac{{ρ}_{p} {U}_{j} {C}_{c} {d}_{p}^{2}}{9 μ W} \qquad ( 1 )$$

where St₅₀ is the Stokes number of a particle having a 50% impaction probability (Marple et al., 1990, 1991; Sioutas et al., 1994), ρₚ is the particle density (g/cm3), Uⱼ is the average velocity of the jet (cm/s), μ is the dynamic viscosity of the air (g/(cm·s)), dₚ is the particle diameter (cm), W is the nozzle width (cm), and C_{c} is Cunningham slip correction factor, Advantageously, when properly optimized, the gelation cascade impactor 10 achieves a high flow rate therethrough with minimal pressure drop through the first slit 16 and the one or more second slits 20. For example, gelatin cascade impactor 10 can be operated at a flow rate of 100 lpm or greater. In a refinement, the first impaction stage has a critical cut-point diameter of about 2.5 μm while the second impaction stage has a critical cut-point diameter of about 0.2 μm, respectively.

In a variation, gelation cascade impactor system 8 can include one or more additional impactor stages upstream of first impaction stage 12 and one or more additional impactor stages downstream of the second impaction stage 14. For example, upstream impaction stage 50 can be configured to remove coarse particles having an average sized greater than the particles collected in first impaction stage 12. Downstream impaction stage 52 can be configured to finer particles than collected in second impaction stage 14.

In a variation, gelation cascade impactor system 8 can also include a filter 60 downstream of the impaction stages. FIG. 1B provides a schematic of a filter holder for the gelatin cascade impactor system. For example, filter 60 can include one or more filter elements 62 and 64 through which air flows.

The following examples illustrate the various embodiments of the present invention. Those skilled in the art will recognize many variations that are within the spirit of the present invention and scope of the claims.

1.1. Gelatin Cascade Impactor Design

The gelatin cascade impactor (shown in FIG. 1) includes two sequential impaction stages along with a filter holder placed downstream of the impactor and is operated at a flow rate of 100 lpm. Gelatin filters with diameters of 47 mm and 80 mm (3.0 μm pore size, Sartorius AG, Germany) were used as particle collection media in the two impaction stages and the after-filter stage, respectively. The detailed specifications of the GCI are expressed in Table 1 which presents the design parameters and the physical characteristics of the impactor based on the theoretical calculations. It should be appreciated that practice within (i.e., +/−), in increasing order of preference, 30%, 20%, 10%, 5%, or 2% of the amounts indicated in Table 1 are also contemplated. As presented in Table 1, the critical cut-point diameters (d₅₀) for the first and second impaction stages of GCI were 2.5 μm and 0.2 m, respectively. They were determined first theoretically for each impaction stage based on the critical Stokes number and then confirmed in laboratory experiments as discussed later below. Following the same procedure, the pressure drop values were determined theoretically as 1 in H₂O (0.25 kPa) and 12 in H₂O (2.98 kPa) for the first and second impaction stages, respectively, and then were verified experimentally. Furthermore, the first impaction stage was designed with one slit nozzle having width and length of 0.33 cm and 2.48 cm, respectively, while the second stage was designed with 6 equally spaced slit nozzles having equal width (0.013 cm) and length (3.12 cm).

TABLE 1
Measured properties

| | First | Second | After- |
|---|---|---|---|
| | stage | stage | filter |
| Substrate Material | Gelatin | Gelatin | Gelatin |
| | Filter | Filter | Filter |
| Substrate diameter (mm) | 47 | 47 | 80 |
| Critical Stokes number St₅₀ | 0.25 | 0.25 | — |
| \sqrt{St₅₀} | 0.5 | 0.5 | — |
| Cut-point d₅₀ (μm) | 2.50 | 0.20 | — |
| ΔP (kPa) | 0.25 | 2.98 | — |
| Jet velocity Uⱼ (cm/s) | 2021 | 7001 | — |
| Flow rate (lpm) | 100 | 100 | 100 |
| Slit nozzle width W (cm) | 0.33 | 0.013 | — |
| Slit nozzle length (cm | 2.48 | 3.12 | — |
| Number of slit nozzles | 1 | 6 | — |

1.2. Impaction Theory

Inertial impaction theory has been widely used for the development of air particulate capturing technologies (e.g., cascade impactors) (Gotoh and Masuda, 2000; Maeng et al., 2007; Marple et al., 1990) and was used for the development of the GCI in this study. The Stokes equation (1) set forth above was employed for designing the cut-point diameter and nozzle dimensions of impactor stages based on the Stokes number of a particle having a 50% impaction probability (St50) (Marple et al., 1990, 1991; Sioutas et al., 1994). The Cunningham slip correction factor C_{c} was estimated using equation (2) (Hinds, 1999):

$${C}_{c} = 1 + \frac{2.52 λ}{{d}_{p}} \qquad ( 2 )$$

where λ is the mean free path of air molecules (cm). Moreover, the jet velocities for both impaction stages in Table 1 were calculated by dividing the GCI flow rate by the nozzle cross-sectional area. The theoretical pressure drop across each impactor stage was calculated based on the following Bernoulli's equation:

$$Δ P = \frac{1}{2} {ρ}_{a} {U}_{j}^{2}$$

where ΔP is the pressure drop (dyn/cm²) and the density of air (ρₐ) is equal to 0.0012 g/cm³.

1.3. Laboratory Characterization of the First and Second Impaction Stages of the GCI

1.3.1. Experimental Setup

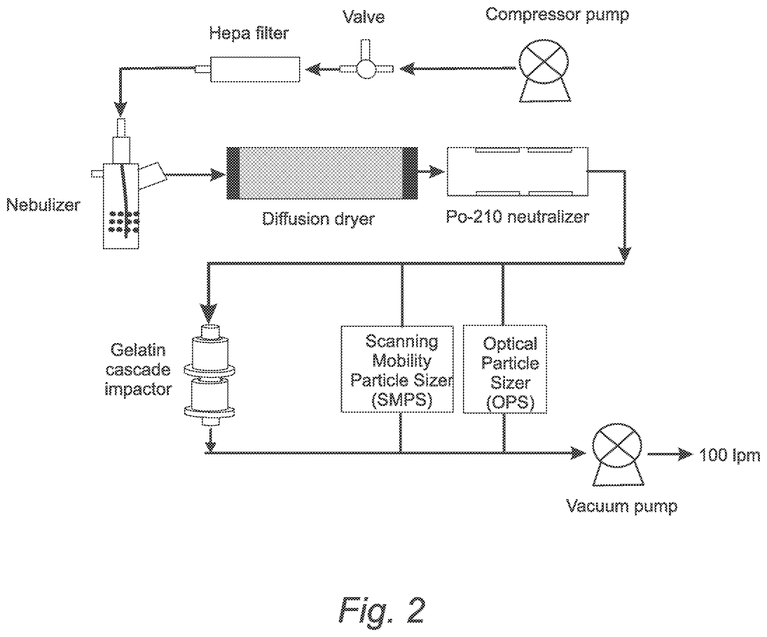

Monodisperse polystyrene latex (PSL) particles along with three different polydisperse aerosols (i.e., sodium chloride (NaCl), ammonium sulfate ((NH₄)₂SO₄), and ammonium nitrate (NH₄NO₃)) were used to determine the particle collection efficiency for each stage of the gelatin cascade impactor. These monodisperse and polydisperse particles were generated in the lab by aerosolizing their aqueous solution using a nebulization system (FIG. 2) (Han et al., 2009; Lim et al., 2020; Soo et al., 2016). FIG. 2 illustrates the schematic of the experimental setup used for the characterization of impaction stages of the GC. At first, the liquid suspensions were converted to airborne aerosols by supplying compressed filtered air to a nebulizer (Model 11310 HOPE™ nebulizer, B&B Medical Technologies, USA) using a compressor pump (Model VP0625-V1014-P2-0511, Medo Inc., USA) equipped with HEPA capsule (Model 12144, Pall Corporation, USA). The aerosolized particles were drawn to a silica-gel diffusion dryer (Model 3062, TSI Inc., USA) to remove the moisture of particles, followed by a glass container having Po-210 neutralizers (Model 2U500, NRD Inc., USA) to minimize the electrical charges of particles. The airborne particles entered the GCI operating with a flow rate of 100 lpm using a high-capacity pump (Model 0523-101-G588NDX, Gast Manufacturing Inc., USA).

Particle collection efficiency (1—particle penetration) was determined as a function of particle size using an optical particle sizer (OPS) (Model 3330, TSI Inc., USA) and a scanning mobility particle sizer (SMPS) (Model 3936, TSI Inc., USA). Since the GCI was designed to allow for decoupling of the first impaction stage from the second stage, we individually characterized each stage to obtain the particle collection efficiency curves using the experimental setup shown in FIG. 2. Given that the OPS and SMPS mainly detect particles in size range of 0.3-10 μm and 0.01-0.7 μm, respectively, the first impaction stage was characterized using the OPS only while the second impaction stage was characterized using both instruments simultaneously (i.e., OPS and SMPS). As shown in the experimental setup schematic, both particle counter instruments were connected upstream and downstream of the impaction stage to measure the difference in particle number concentrations before and after the impactor. Equation (4) was used for calculating the collection efficiency of particles for each impaction stage:

$$CE = \frac{{PN}_{u} - {PN}_{d}}{{PN}_{u}} \times 100 \% \qquad ( 4 )$$

where CE is the particle collection efficiency and PNᵤ and PN_{d} are particle number concentrations upstream and downstream of the impactor, respectively. Additionally, the pressure was also experimentally measured upstream and downstream of each impaction stage using a Magnehelic pressure gauge (Model series 2000, Dwyer Instruments Inc., USA) to calculate the pressure drop as a function of the air flow rate.

1.3.2. Mass Loading Tests

In addition to the laboratory characterization of GCI described above, the performance of GCI equipped with gelatin filter was compared with a personal cascade impactor sampler (PCIS) (Model 225-370, SKC Inc., USA) equipped with PTFE (Teflon) filter (Pall Life Sciences Inc., USA). Laboratory experiments were performed employing both impactors in parallel to collect artificially generated test aerosols (i.e., sodium chloride, ammonium nitrate, and glutaric acid) and then calculate the mass concentrations (g/m³) of the collected particles. For each test aerosol, the experiments were carried out to compare the particle mass concentrations measured by the GCI first and second impaction stages with those determined by the PCIS 2.5 μm and 0.25 μm cut-point stages, respectively. Prior to the above-mentioned laboratory tests, all filters and substrates were kept in a room with a controlled temperature of 22-24° C. and relative humidity of 40-50% to equilibrate and then were weighed before and after the experiments using Mettler 5 microbalance (MT5, Mettler Toledo Inc., USA) to determine the collected mass from the difference between their final and initial weights.

1.4. Analysis of Blank Gelatin Filters

1.4.1. Chemical and Toxicological Analyses

Blank gelatin and PTFE filters having equal size (47 mm) were analyzed in the Wisconsin State Lab of Hygiene (WSLH) at the University of Wisconsin-Madison. The blank filters were analyzed for their inorganic ions, metals, and trace elements. The inorganic ions were assessed using ion chromatography (IC), while the metals and trace elements were measured by inductively coupled plasma mass spectroscopy (ICP-MS) (Karthikeyan and Balasubramanian, 2006; Lough et al., 2005). Furthermore, the redox activity of the filters was assessed by means of the macrophage-based reactive oxygen species (ROS) and dithiothreitol consumption (DTT) assays. At first, aqueous solutions of the filters were prepared using Type 1 ultrapure Milli-Q water (resistivity 18.2 MΩ cm at 25° C., total organic carbon (TOC)≤5 ppb) for the use in both assays. ROS assay was performed by exposing highly responsive rat alveolar macrophage cells to the liquid solution and using dichlorodihydrofluorescein diacetate (DCFH-DA) as the fluorescent probe to assess the ROS activity. DCFH-DA was employed in ROS assay since it is responsive to main radioactive oxygen species, including hydroxyl, peroxide, and superoxide radicals (Carranza and Pantano, 2003; Schoonen et al., 2006). More details related to ROS assay are described in Landreman et al. (2008). Furthermore, the DTT assay has been widely used for measuring the redox activity of PM samples (Delfino et al., 2013; Kumagai and Shimojo, 2002; Shima et al., 2006). This assay measures the DTT consumption in the filter extract and its conversion to the disulfide form, in which the linear rate of DTT depletion is proportional to the oxidative potential (toxicity) of the analyzed sample. Further details regarding the DTT assay can be found in Kumagai et al. (2002) and Shafer et al. (2016).

1.4.2. Particle Number Concentrations

A blank gelatin filter with an average mass of 63.20 mg was dissolved in 220 ml of ultrapure Milli-Q water using an ultrasonic bath for 30 min to form a homogenous solution with a concentration of approximately 287 μg/ml. The blank gelatin slurry was analyzed for the particle number concentrations using the nebulization system setup described previously, in which the slurry was aerosolized and then drawn through the SMPS inlet port to measure the number-based size distribution. For the purpose of comparison, we collected ambient ultrafine PM (UFP) on PTFE filter (20×25 cm, 2.0 μm pore size, PALL Life Sciences, USA) using a high-flow-rate PM sampler that has a cut-point diameter of 0.18 μm to separate accumulation from ultrafine PM (Misra et al., 2002). The collected particles were extracted in an ultrapure Milli-Q water to form a liquid suspension having a concentration of 275 μg/ml (i.e., similar to the concentration of the blank gelatin suspension) that was re-aerosolized using the previously discussed nebulization system.

1.5. Field Evaluation of Gelatin Cascade Impactor

In addition to the laboratory characterization of the GCI, field tests were conducted using GCI and PCIS equipped with gelatin and PTFE filters, respectively. The field location was near the University of Southern California (USC) main campus in downtown Los Angeles, CA, and in close proximity to a major highway (I-110). This location site has been extensively used in previous publications since it represents a mixture of various urban sources emitting PM in different sizes and chemical compositions (Moore et al., 2007; Ning et al., 2007; Sardar et al., 2005). The aerosol samplers (i.e., GCI and PCIS) were placed in a controlled indoor environment (i.e., a sampling unit) and connected to the outdoor environment using an aluminum tube to sample ambient air, which will equilibrate to room temperature once it enters the controlled indoor space. It should be noted that placing the GCI in an outdoor environment to conduct field experiments might be problematic, especially in fall and winter seasons, because the higher relative humidity prevailing during these periods might compromise the quality of the gelatin substrates. Before initiating these field experiments, the PTFE and gelatin filters were kept in a standard laboratory condition (i.e., temperature of 22-24° C. and relative humidity of 40-50%) to equilibrate and then obtain their pre-sampling weights. After sampling, the filters were weighed to calculate the collected mass on each filter from the difference between the post-sampling and the pre-sampling weights.

Prior to starting the field sampling, we conducted a series of field tests to assess the durability of gelatin filters in withstanding long-term sampling durations. These field experiments were carried out with different sampling durations (e.g., 1 day, 2 days, 5 days) to collect ambient particles on gelatin substrates using the GCI. We realized that exceeding 24-hr of sampling resulted in damaging the gelatin filters as they were torn apart and separated into smaller pieces. Therefore, we performed short-term sampling (24 h) to compare the oxidative potential of PM2.5 (dp<2.5 μm) samples using the GCI and the PCIS simultaneously. For the collection of PM2.5, we employed the GCI first impaction stage and the PCIS 2.5 μm cut-point stage and placed an 80 mm gelatin filter and a 37 mm PTFE filter in their after-filter stages, respectively. Given that the PCIS operates at low flow rate (i.e., 9 lpm), we used two PCIS simultaneously on each sampling day to allow for the collection of sufficient PM mass loadings (>300 μg) on two PTFE filters, which were composed together to form a slurry for the toxicological analysis. The mass loading was not an issue in GCI since it was operating at flow rate of 100 lpm, allowing for an average collection of more than 2 mg of PM2.5 each day. After concluding five daily field experiments, the collected samples were sent to Wisconsin state lab of hygiene to measure the redox activity of particles using DTT and ROS assays.

2. RESULTS AND DISCUSSION

2.1. Laboratory Experiments Using Artificially Generated Test Aerosols

2.1.1. Pressure Drop and Collection Efficiency Curves

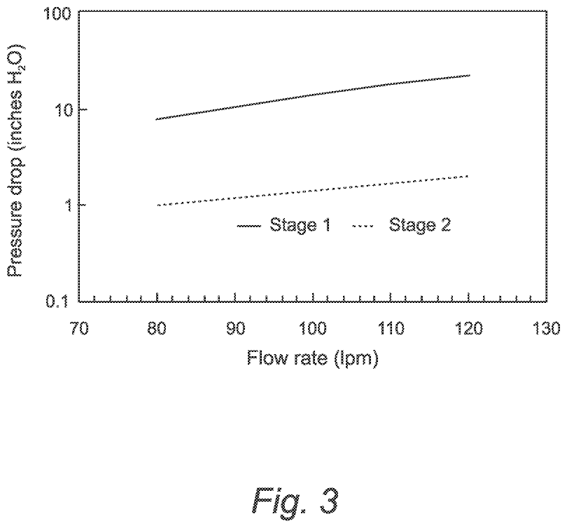

Using the experimental setup discussed earlier, the pressure drop was measured for both impaction stages and plotted as a function of GCI air flow rate as shown in FIG. 3. By operating the GCI at a flow rate of 100 lpm, the pressure-drop values for the first and second impaction stages were experimentally measured as 1.4 in H₂O (0.35 kPa) and 14.2 in H₂O (3.53 kPa), respectively. These pressure-drop values agreed with the theoretical predictions (Table 1) of the first and second impaction stages. Maintaining low pressure drop (≤3.5 kPa) in both impaction stages was necessary to minimize evaporation losses of volatile components (Furuuchi et al., 2010).

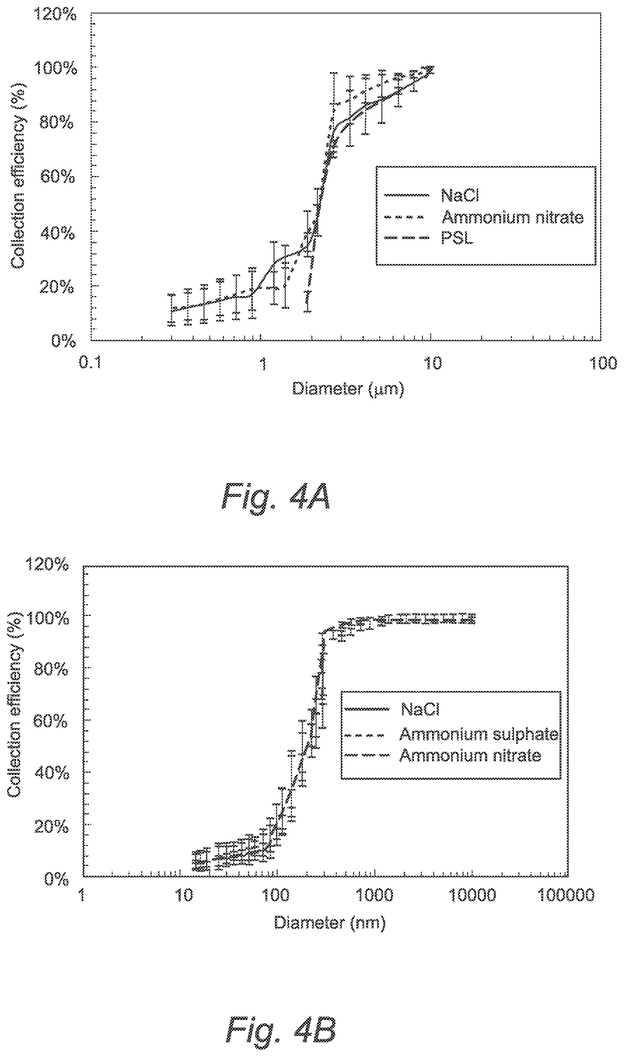

Additionally, FIG. 4 shows the particle collection efficiency curves for both impaction stages using gelatin filters as impaction substrates. FIG. 4 (a) shows the collection efficiency data as a function of particle size for the first impaction stage using three laboratory-generated aerosols, including PSL, sodium chloride, and ammonium nitrate. The collection efficiency increased rapidly in the range of 2-3 μm and was higher than 90-95% for particles larger than 5 μm, corroborating the fact that the GCI equipped with gelatin substrate efficiently minimized coarse particle bouncing and re-entrainment losses. All three test aerosols showed a very good agreement in the critical (50%) cut-point diameter of the first impaction stage, which was approximately 2.4 μm, corresponding to a Stokes number of 0.27 (√St50=0.52). The figure also demonstrated that the lab aerosols had the same particle size distribution, except of the monodisperse PSL particles (size range of 1.9-7 μm) which were coarse particles and used for the characterization of the first impaction stage only. Transitioning to the second impaction stage, FIG. 4 (b) shows the collection efficiency curves using three polydisperse aerosols, including ammonium sulfate, ammonium nitrate, and sodium chloride. The collection efficiency increased sharply in the particle size range of 0.16-0.27 μm and approached approximately 99% for particles larger than 0.3 μm, which also indicated that the particle losses and bounce-off were not significant in the GC. Similar to the first stage, the 50% cutpoint diameter was in good agreement across the three analyzed aerosols and was, on average, 0.21 μm, corresponding to a Stokes number of 0.29 (√St50=0.54).

The experimental values of the 50% cut-point diameters for both impaction stages were very consistent with the theoretical predictions shown in Table 1. Additionally, the experimentally measured square root of Stokes numbers (√St50) for the first and second impaction stages were 0.52 and 0.54, respectively, and were consistent with previous studies that reported experimentally determined √St50 values in the range of 0.4-0.6 for impactors with rectangular nozzle (Demokritou et al., 2002, 2004; Misra et al., 2002; Sioutas et al., 1994). However, they were lower than the theoretical √St50 value (0.77) calculated for a slit-nozzle impactor with a flat rigid substrate (Hinds, 1999). The lower √St50 with respect to the rigid surface is most likely due to the penetration of particles into the pores of the gelatin substrate, causing a slight increase in the collection efficiency and minimizing the particle losses and bouncing-off. Previous studies reported similar results by achieving lower √St50 values than the theoretically calculated for rigid surfaces because of the use of polyurethane foam (PUF) as an impaction substrate (Kavouras et al., 2000; Kavouras and Koutrakis, 2001). The sharpness of the collection efficiency curves was assessed by the geometric standard deviation (GSD) value obtained from the square root of the ratio of particle diameter corresponding to 84.1% collection efficiency to the diameter of 15.9% collection efficiency (Demokritou et al., 2002; Kang et al., 2012; Marple et al., 2004). The GSD of the collection efficiency curves of the test aerosols in the first and second impaction stages were in the range of 1.4-1.5, indicating sharp inertial separation of particles.

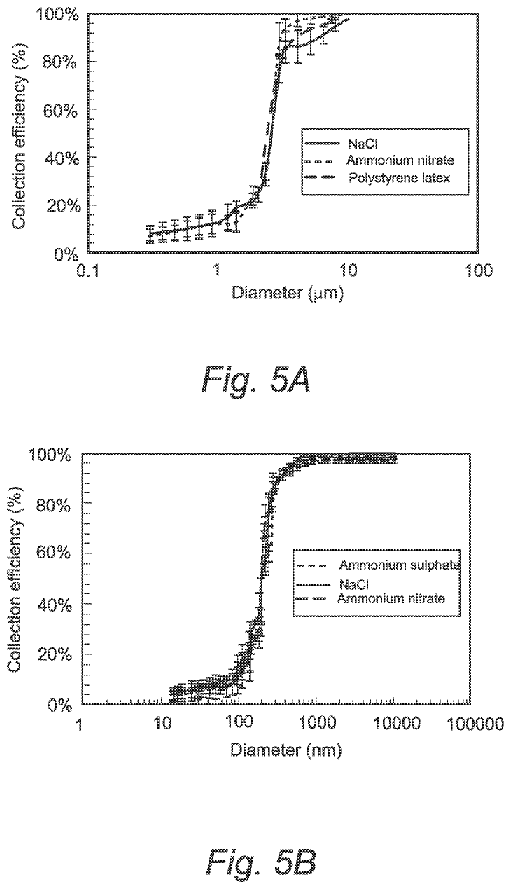

In addition to the use of gelatin as impaction substrates, we employed 47 mm quartz filters in both impaction stages to obtain particle collection efficiency curves using the same procedure and laboratory-generated aerosols described earlier. FIG. 5 shows that the use of quartz filters led to similar collection efficiency patterns and the same 50% cut-point diameters in comparison with gelatin substrates. Therefore, GCI can also be used with different substrates (e.g., quartz, Teflon) without any changes in its technical specifications and particle separation characteristics.

2.1.2. The Comparison of Particle Loading Between GCI and PCIS

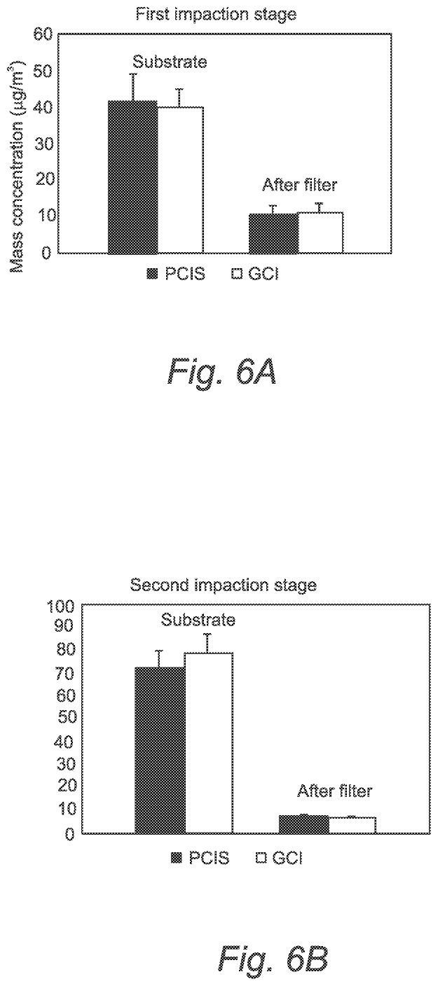

FIG. 6 shows the average mass concentrations of particles collected on gelatin and PTFE substrates using GCI and PCIS, respectively. The data shown in the figure are based on the average value of the three test aerosols (i.e., sodium chloride, ammonium nitrate, and glutaric acid) used in the laboratory experiments. FIG. 6 (a) presents the mass concentration results based on the first impaction stage of GCI and the 2.5 μm cut-point stage of the PCIS. Given that both stages had 50% cut-point diameters of approximately 2.5 μm, the findings show an excellent agreement between both impactors with a minimal variability of 3.3% and 4.2% for the impaction substrate and after-filter, respectively. Moreover, FIG. 6 (b) also demonstrates consistency in mass concentration between both impactors using 0.25 μm cut-point stage of the PCIS and the second impaction stage of the GCI, along with their after-filter stages. The variability in mass concentrations between the GCI and PCIS were 8.1% and 9.3% for the impaction substrate and after-filter, respectively. The higher mass concentration variability between the GCI and PCIS in this experiment was attributed to the slight difference in the 50% cut-point diameter between the PCIS 0.25 μm stage and GCI second impaction stage, which also explains the higher mass concentration of the PCIS over the GCI in the after-filter stage.

2.2. Filter Blank Analysis

2.2.1. Chemical and Toxicological Analyses

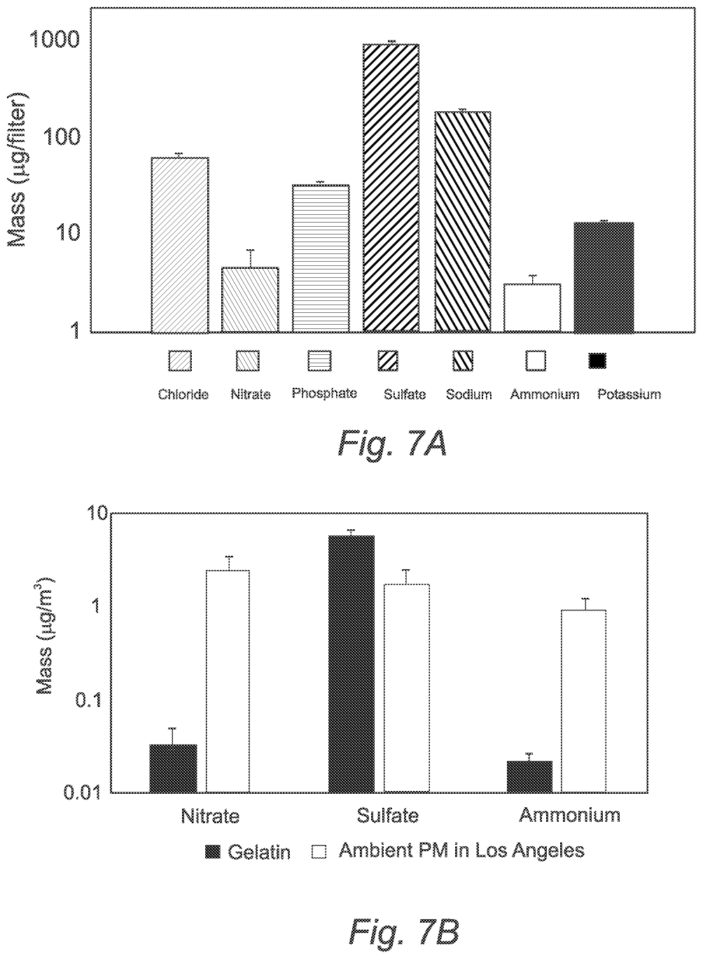

The IC analysis results are presented in FIG. 7 (a), which illustrates the levels of inorganic ions found on blank gelatin filter. The levels of inorganic ions in the blank gelatin were approximately less than 150 μg/filter, excluding sulfate which showed a concentration of 860 μg/filter. Considering the maximum sampling duration (i.e., 24 h) of the gelatin filter and the operational flow rate (i.e., 100 lpm) of the GCI, the levels of inorganic ions in the blank gelatin filter were converted to airborne concentrations in units of mass per volume of air (m3). The comparison of volume-based values with typical inorganic ion content in ambient PM in Los Angeles (Pirhadi et al., 2020) is shown in FIG. 7 (b). According to the figure, the inorganic ion levels in the blank gelatin (<0.05 μg/m3) were substantially lower than the levels in ambient PM, except sulfate (5.97 μg/m³) which was more than twice its level in the ambient air (1.73 μg/m³) in Los Angeles. Considering that ammonium sulfate is a major constituent of PM2.5, these results preclude the use of gelatin substrates for inorganic PM ion analysis, but as we noted earlier, the main purpose of using these substrates was for toxicological analysis and more suitable substrates (e.g., quartz or Teflon) can be used with the GCI for the characterization of the inorganic ion content of PM.

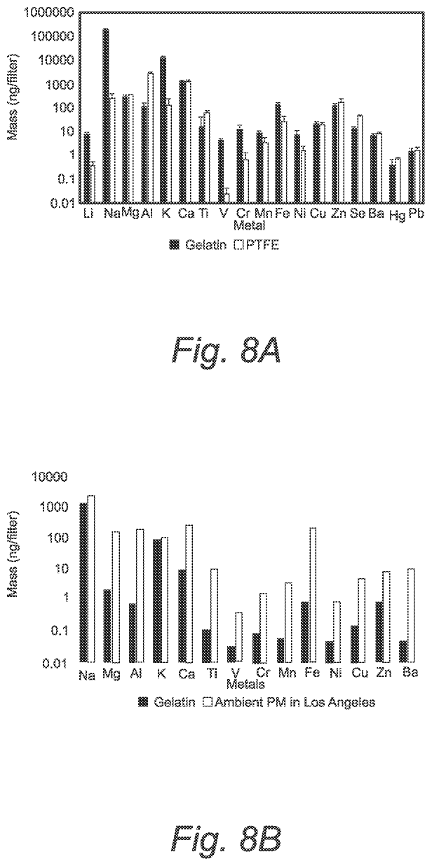

FIG. 8 (a) shows the results of ICP-MS analysis for metals and trace elements in blank gelatin and PTFE filters having equal size (i.e., 47 mm). The levels of most metals and trace elements in the blank gelatin were approximately in the range of 10-10,000 ng/filter, with the exception of sodium (Na) and potassium (K) which were much higher than other metals with concentrations of 176,758 and 11,668 ng/filter, respectively. It is worth noting that some of these selected metals had negligible values (less than 10 ng/filter), including lithium (Li), manganese (Mn), nickel (Ni), barium (Ba), mercury (Hg), and lead (Pb). The findings also highlight that the concentrations of several metals in gelatin exceeded that of PTFE, including potassium (K), vanadium (V), sodium (Na), and chrome (Cr), especially Na whose concentration in gelatin was 735 times its concentration in the PTFE filter. It is also notable that the blank levels of most redox-active metals (i.e., Fe, Cu, Ti, Zn, Pb, Ba, Mn) were in a comparable range in the two filters. Following the same procedure discussed earlier to convert blank levels to airborne concentrations per volume of air, we expressed the blank metals and trace elements in units of ng/m3 of air in FIG. 8 (b) and compared them with the ambient PM in Los Angeles (Pirhadi et al., 2020). As shown in the figure, the levels of most metals and trace elements in the blank gelatin (<1 ng/m3) were lower than those in the ambient air by one order of magnitude or higher. However, the concentrations of sodium and potassium in the blank gelatin were in a comparable range with the ambient levels.

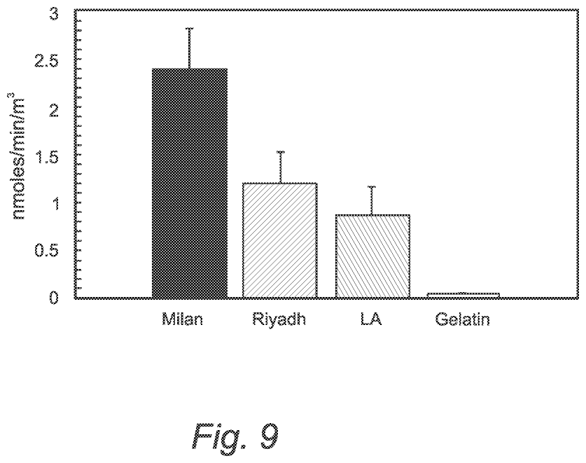

The toxicological analysis showed that the average oxidative potential levels in the blank gelatin filter based on DTT and ROS assays were 5.19±0.88 nmol/min/filter and 367.3±89.5 μg Zymosan/filter, respectively. The blank redox activity values of the gelatin filter were in a comparable range with the blank PTFE filter, which had DTT and ROS activities of 3.92±0.67 nmol/min/filter and 283.4±72.9 μg Zymosan/filter, respectively. Furthermore, extensive studies used DTT assay to determine the oxidative potential of PM collected samples in different locations around the globe (i.e., Milan, Los Angeles, and Riyadh) (Altuwayjiri et al., 2022; Cho et al., 2005; Farahani et al., 2022; Hakimzadeh et al., 2020; Saffari et al., 2014). FIG. 9 shows the comparison of the normalized DTT activity (per volume of air) of the blank gelatin filter with the ambient PM in the three major cities. According to the figure, the DTT activity of the blank gelatin (0.036±0.006 nmol/min/m³) is much lower than the ambient PM in Milan, Los Angeles, and Riyadh which had average oxidative potential levels of 2.4±0.43, 0.88±0.29, and 1.2±0.32 nmol/min/m3, respectively. Therefore, gelatin filters can be used as substrates for the collection of PM samples for toxicological analysis since their blank redox activity values were in a comparable range with other substrates (i.e., PTFE) and were considerably low compared to the DTT responses recorded in typical ambient PM around the world.

2.2.2. Particle Number Concentrations of Re-Aerosolized Gelatin Blank Filters and Filters with Ambient PM

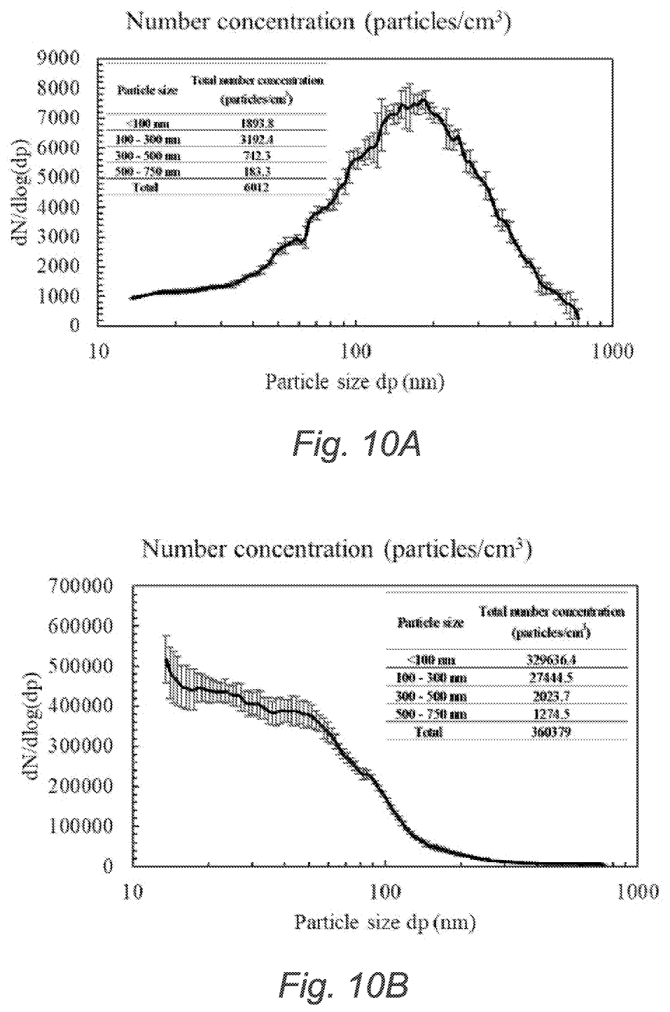

The SMPS was employed to assess the particle number concentrations of the two suspensions (i.e., blank gelatin and UFP) by aerosolizing the slurries using the typical nebulization system illustrated in the methodology section. Accordingly, the particle number distribution curves as a function of particle diameter were obtained and presented in FIG. 10 for the blank gelatin and UFP slurries. As clearly shown in the figure, the particle number concentration for UFP exceeded the blank gelatin by approximately two orders of magnitudes. The total particle number concentrations for blank gelatin and UFP suspensions were 6012±248 and 360,379±21,757 particles/cm3, respectively. This considerably low particle number concentration of the blank gelatin in comparison with UFP further corroborates the use of gelatin filters in the field of aerosol sampling.

2.3. Field Comparison Between the Oxidative Potential of Particles Collected Using the GCI and the PCIS

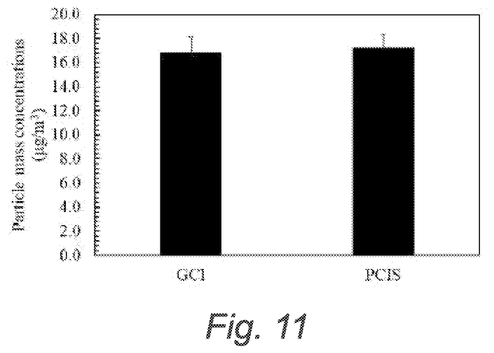

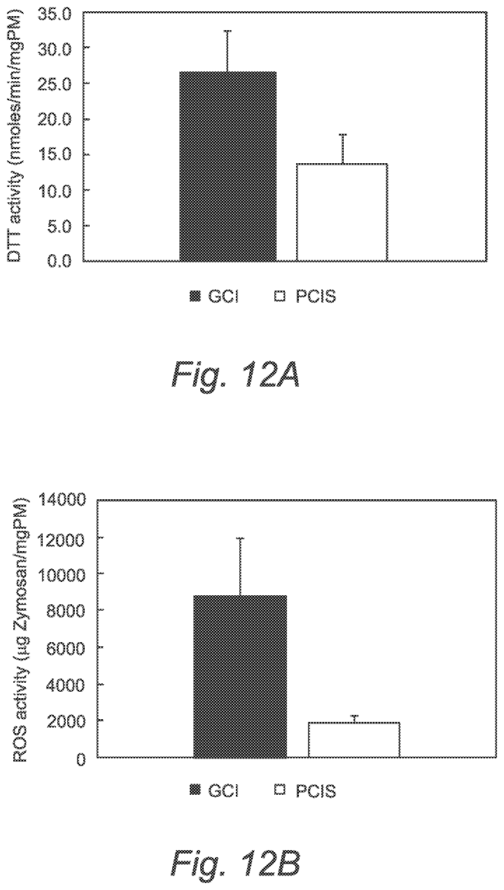

Before performing the toxicological analysis on the collected PM2.5 samples, the ambient particle mass concentrations obtained by the GCI and PCIS were compared in FIG. 11, which shows a very good agreement between the two samplers (i.e., minimal variability of less than 3%). The consistency between the GCI equipped with gelatin substrate and the PCIS equipped with PTFE substrate corroborates the suitable use of gelatin filters in field sampling without any issues related to water absorption. The collected PM2.5 samples were then analyzed using DTT and ROS assays in order to compare the redox activity of particles collected on gelatin filters using the GCI with particles collected on PTFE filters using the PCIS. It should be noted that the blank redox activity values of gelatin and PTFE filters were subtracted from the redox activity of the collected PM2.5 samples. For comparison purposes, we normalized the redox activity to PM mass, obtained from the gravimetric analysis, to express the values in units of g Zymosan Units/mg PM and nmoles/min/mg PM for ROS and DTT, respectively. FIG. 12 (a) shows the results of the DTT assay in which the oxidative potential of particles collected using the GCI was approximately twice the PCIS, with redox activities of 26.44 nmol/min/mg PM and 13.56 nmol/min/mg PM for the GCI and PCIS, respectively. In addition, the ROS results shown in FIG. 12 (b) further corroborate the ability of the GCI to achieve higher particle redox activity values in comparison with the PCIS. As illustrated in the figure, the ROS activity of particles collected using GCI equipped with gelatin filter (8813.2 μg Zymosan Units/mg PM) is more than 4 times the redox activity of particles collected on PTFE filter using PCIS (1909.1 μg Zymosan Units/mg PM). The higher PM oxidative potential of the GCI compared to the PCIS might be attributed to the superiority of the GCI in capturing water-insoluble redox-active PM species (e.g., elemental carbon, PAH, other insoluble organics, and transition metals such as iron, lead, nickel). Previous studies have reported the significant contribution of water-insoluble compounds to the oxidative potential of PM2.5 (Daher et al., 2011; Pirhadi et al., 2020). D. Wang et al. (2013) conducted an experiment using aerosol-into-liquid collector to compare the ROS levels of two PM2.5 suspensions, one of which was filtered from the water-insoluble species. They concluded that the filtered suspension resulted in approximately 30% lower ROS activity than the unfiltered slurry, further underscoring the effective role of insoluble compounds in the overall redox activity of PM2.5. These observations support the efficiency of using the GCI in collecting ambient PM for further toxicological studies and in-vivo and in-vitro assays.

### 3. SUMMARY AND CONCLUSION

In this study, a two-stage gelatin cascade impactor was developed and evaluated in the laboratory as well as in field experiments. The GC operates at a high flow rate of 100 lpm and consists of two impaction stages with 2.5 μm and 0.2 μm cut-point diameters, respectively. The pressure drop values in both impaction stages were low (≤3.5 kPa) in order to minimize evaporation losses of volatile components. Furthermore, laboratory experiments were conducted using artificially produced aerosols to corroborate the agreement of the GCI with the PCIS in terms of the mass concentration of collected particles, which showed a minimal variability of less than 10% between both impactors. In addition to the lab experiments, field experiments were carried out to collect PM2.5 particles on PTFE and gelatin filters using PCIS and GCI, respectively. Since the GCI was operated with a high sampling flow rate (100 lpm), it was able to collect considerable amounts of PM in 24 h intervals. The field tests corroborated the higher particle oxidative potential levels measured by the GCI in comparison with the PCIS based on both DTT and ROS assays. The DTT and ROS activities of particles collected using the GCI were 26.44 nmol/min/mg PM and 8813.2 μg Zymosan Units/mg PM, respectively, which were more than twice the redox activities of particles collected by the PCIS. This can be attributed to the superiority of the GCI in capturing water-insoluble redox-active PM species on gelatin filters, which were dissolved in water to extract all collected particles. Although gelatin filters offer significant advantages to the field of aerosol sampling, they might not be suitable for PM chemical characterization studies due to the elevated blank levels of some metals and inorganic ions (e.g., sulfate, sodium). In addition, field experiments to collect ambient PM on gelatin filters should be limited to 24-hr sampling duration to avoid any possible damage to the filter media. If PM chemical analysis or long-term sampling durations are required, the GCI can be equipped with different types of substrates without any significant change in its technical specifications or particle separation characteristics, as was verified experimentally by the use of quartz and gelatin substrates. The GCI is a significant technological contribution to air pollution studies and the field of aerosol sampling due to its ability to achieve high-volume collection of multi-sized PM without significant particle bouncing and re-entrainment losses. It also enables researchers in the field of environmental health to conduct inhalation and toxicological studies using water-soluble filters (i.e., gelatin) that can easily dissolve in water and achieve a particle extraction efficiency of 100%. The GCI equipped with gelatin filters is a powerful replacement for traditional cascade impactors due to its advantages in collecting considerable amounts of real-life PM redox-active constituents and preserving their chemical compositions for further toxicity assays.

Additional detail for the the cascade impactor and system described above are set forth in Mohammad Aldekheel, Vahid Jalali Farahani, Ramin Tohidi, Abdulmalik Altuwayjiri, Constantinos Sioutas, Development and performance evaluation of a two-stage cascade impactor equipped with gelatin filter substrates for the collection of multi-sized particulate matter, Atmospheric Environment, Volume 294, 2023, 119493, ISSN 1352-2310, https://doi.org/10.1016/j.atmosenv.2022.119493. (https://www.sciencedirect.com/science/article/pii/S1352231022005581); the entire disclosure of which is hereby incorporated by reference in its entirety.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

Altuwayjiri, A., Pirhadi, M., Kalafy, M., Alharbi, B., Sioutas, C., 2022. Impact of different sources on the oxidative potential of ambient particulate matter PM10 in Riyadh, Saudi Arabia: a focus on dust emissions. Sci. Total Environ. 806. https://doi.org/10.1016/j.scitotenv.2021.150590.

Anderson, J. O., Thundiyil, J. G., Stolbach, A., 2012. Clearing the air: a review of the effects of particulate matter air pollution on human health. J. Med. Toxicol. 8 (2), 166-175. https://doi.org/10.1007/s13181-011-0203-1.
Appert, J., Raynor, P. C., Abin, M., Chander, Y., Guarino, H., Goyal, S. M., Zuo, Z., Ge, Z., Kuehn, T. H., 2012. Influence of suspending liquid, impactor type, and substrate on size-selective sampling of MS2 and adenovirus aerosols. Aerosol Sci. Technol. 46 (3), 249-257. https://doi.org/10.1080/02786826.2011.619224.
Biswas, K., Gupta, T., 2017. Design and development of a novel PM inertial impactor with reduced particle bounce off. J. Energy Environ. Sustain. 3, 20-24.
Carranza, S. E., Pantano, P., 2003. Fluorescence microscopy and flow cytofluorometry of reactive oxygen species. Appl. Spectrosc. Rev. 38 (Issue 2), 245-261. https://doi. org/10.1081/ASR-120021168.
Chan, V. W. M., So, S. Y. C., Chen, J. H. K., Yip, C. C. Y., Chan, K. H., Chu, H., Chung, T. W. H., Sridhar, S., To, K. K. W., Chan, J. F. W., 2020. Air and environmental sampling for SARS-CoV-2 around hospitalized patients with coronavirus disease 2019 (COVID-19). Infect. Control Hosp. Epidemiol. 41 (11), 1258-1265. https://doi.org/10.1017/ice.2020.282.
Chen, M., Romay, F. J., Marple, V. A., 2018. Design and evaluation of a low flow personal cascade impactor. Aerosol. Sci. Technol. 52 (2), 192-197. https://doi.org/10.1080/02786826.2017.1388498.
Cho, A. K., Sioutas, C., Miguel, A. H., Kumagai, Y., Schmitz, D. A., Singh, M., Eiguren-Fernandez, A., Froines, J. R., 2005. Redox activity of airborne particulate matter at different sites in the Los Angeles Basin. Environ. Res. 99 (1), 40-47. https://doi.org/10.1016/j.envres.2005.01.003.
Clifford, S., Mazaheri, M., Salimi, F., Ezz, W. N., Yeganeh, B., Low-Choy, S., Walker, K., Mengersen, K., Marks, G. B., Morawska, L., 2018. Effects of exposure to ambient ultrafine particles on respiratory health and systemic inflammation in children. Environ. Int. 114, 167-180. https://doi.org/10.1016/j.envint.2018.02.019.
Daher, N., Ning, Z., Cho, A. K., Shafer, M., Schauer, J. J., Sioutas, C., 2011. Comparison of the chemical and oxidative characteristics of particulate matter (PM) collected by different methods: filters, impactors, and BioSamplers. Aerosol. Sci. Technol. 45 (11), 1294-1304. https://doi.org/10.1080/02786826.2011.590554.
Delfino, R. J., Staimer, N., Tjoa, T., Gillen, D. L., Schauer, J. J., Shafer, M. M., 2013. Airway inflammation and oxidative potential of air pollutant particles in a pediatric asthma panel. J. Expo. Sci. Environ. Epidemiol. 23 (5), 466-473. https://doi.org/10.1038/jes.2013.25.
Demokritou, P., Kavouras, I. G., Ferguson, S. T., Koutrakis, P., 2002. Development of a high volume cascade impactor for toxicological and chemical characterization studies. Aerosol. Sci. Technol. 36 (9), 925-933. https://doi.org/10.1080/02786820290092113.
Demokritou, P., Lee, S. J., Koutrakis, P., 2004. Development and evaluation of a high loading PM2.5 speciation sampler. Aerosol. Sci. Technol. 38 (2), 111-119. https://doi.org/10.1080/02786820490249045.
Fabian, B., McDevitt, J. J., Houseman, E. A., Milton, D. K., 2009. Airborne influenza virus detection with four aerosol samplers using molecular and infectivity assays: Considerations for a new infectious virus aerosol sampler. Indoor Air 19 (5), 433-441. https://doi.org/10.1111/j.1600-0668.2009.00609.x.
Farahani, V. J., Altuwayjiri, A., Pirhadi, M., Verma, V., Ruprecht, A. A., Diapouli, E., Eleftheriadis, K., Sioutas, C., 2022. The oxidative potential of particulate matter (PM) in different regions around the world and its relation to air pollution sources. Environ. Sci.: Atmosphere 2 (5), 1076-1086. https://doi.org/10.1039/D2EA00043A.
Furuuchi, M., Eryu, K., Nagura, M., Hata, M., Kato, T., Tajima, N., Sekiguchi, K., Ehara, K., Seto, T., Otani, Y., 2010. Development and performance evaluation of air sampler with inertial filter for nanoparticle sampling. Aerosol Air Qual. Res. 10 (2), 185-192. https://doi.org/10.4209/aaqr.2009.11.0070.
Gauderman, W. J., Urman, R., Avol, E., Berhane, K., McConnell, R., Rappaport, E., Chang, R., Lurmann, F., Gilliland, F., 2015. Association of improved air quality with lung development in children. N. Engl. J. Med. 372 (10), 905-913. https://doi.org/10.1056/NEJMoa1414123.
George, K. V., Patil, D. D., Kumar, P., Alappat, B. J., 2012. Field comparison of cyclonic separator and mass inertial impactor for PM10 monitoring. Atmos. Environ. 60, 247-252. https://doi.org/10.1016/j.atmosenv.2012.06.026.
Gerlofs-Nijland, M. E., Rummelhard, M., Boere, A. J. F., Leseman, D. L. A. C., Duffin, R., Schins, R. P. F., Borm, P. J. A., Sillanp*a*a, M., Salonen, R. O., R Cassee, F., 2009. Particle induced toxicity in relation to transition metal and polycyclic aromatic hydrocarbon contents. Environ. Sci. Technol. 43 (13), 4729-4736. https://doi.org/10.1021/es803176k.
Gotoh, K., Masuda, H., 2000. Improvement of the classification performance of a rectangular jet virtual impactor. Aerosol. Sci. Technol. 32 (3), 221-232. https://doi. org/10.1080/027868200303759.
Hakimzadeh, M., Soleimanian, E., Mousavi, A., Borgini, A., de Marco, C., Ruprecht, A. A., Sioutas, C., 2020. The impact of biomass burning on the oxidative potential of PM2.5 in the metropolitan area of Milan. Atmos. Environ. 224 https://doi.org/10.1016/j. atmosenv.2020.117328.
Han, B., Hudda, N., Ning, Z., Kim, H. J., Kim, Y. J., Sioutas, C., 2009. A novel bipolar charger for submicron aerosol particles using carbon fiber ionizers. J. Aerosol Sci. 40 (4), 285-294. https://doi.org/10.1016/j.jaerosci.2008.11.005.
Hinds, W. C., 1999. Aerosol Technology: Properties, Behavior, and Measurement of Airborne Particles. John Wiley & Sons.
Huang, R.-J., Yang, L., Shen, J., Yuan, W., Gong, Y., Guo, J., Cao, W., Duan, J., Ni, H., Zhu, C., Dai, W., Li, Y., Chen, Y., Chen, Q., Wu, Y., Zhang, R., Dusek, U., O'Dowd, C., Hoffmann, T., 2020. Water-insoluble organics dominate Brown carbon in wintertime urban aerosol of China: chemical characteristics and optical properties. Environ. Sci. Technol. 54 (13), 7836-7847. https://doi.org/10.1021/acs.est.Oc01149.
Jacoby, J., Bau, S., Witschger, O., 2011. CAIMAN: a versatile facility to produce aerosols of nanoparticles. J. Phys. Conf. 304, 012014 https:/dio.org/10.1088/1742-6596/ Toxicol. 12 (Suppl. 1), 121-137. https://doi.org/10.1080/0895-8378.1987.11463187.
Kim, S., Jaques, P. A., Chang, M., Froines, J. R., Sioutas, C., 2001. Versatile aerosol concentration enrichment system (VACES) for simultaneous in vivo and in vitro evaluation of toxic effects of ultrafine, fine and coarse ambient particles Part I: development and laboratory characterization. J. Aerosol Sci. 32 (11), 1281-1297. https://doi.org/10.1016/S0021-8502(01)00057-X.
Krieger, U. K., Marcolli, C., Reid, J. P., 2012. Exploring the complexity of aerosol particle properties and processes using single particle techniques. Chem. Soc. Rev. 41 (19), 6631. https://doi.org/10.1039/c2cs35082c.
Kumagai, Y., Koide, S., Taguchi, K., Endo, A., Nakai, Y., Yoshikawa, T., Shimojo, N., 2002. Oxidation of proximal protein sulfhydryls by phenanthraquinone, a component of diesel exhaust particles. Chem. Res. Toxicol. 15 (4), 483-489. https://doi.org/10.1021/tx0100993.
Kumagai, Y., Shimojo, N., 2002. Possible mechanisms for induction of oxidative stress and suppression of systemic nitric oxide production caused by exposure to environmental chemicals. Environ. Health Prev. Med. 7 (4), 141-150. https://doi.org/10.1265/ehpm.2002.141.
Landreman, A. P., Shafer, M. M., Hemming, J. C., Hannigan, M. P., Schauer, J. J., 2008. A macrophage-based method for the assessment of the reactive oxygen species (ROS) activity of atmospheric particulate matter (PM) and application to routine (daily-24 h) aerosol monitoring studies. Aerosol. Sci. Technol. 42 (11), 946-957. https://doi. org/10.1080/02786820802363819.
Lim, J. H., Park, D., Yook, S. J., 2020. Development of a multi-slit virtual impactor as a high-volume bio-aerosol sampler. Separ. Purif Technol. 250 https://doi.org/10.1016/j.seppur.2020.117275.
Liu, Y., Ning, Z., Chen, Y., Guo, M., Liu, Y., Gali, N. K., Sun, L., Duan, Y., Cai, J., Westerdahl, D, Liu, X, Xu, K., Ho, K. fai, Kan, H., Fu, Q., Lan, K., 2020. Aerodynamic analysis of SARS-CoV-2 in two Wuhan hospitals. Nature 582 (7813), 557-560. https://doi.org/10.1038/s41586-020-2271-3.
Lough, G. C., Schauer, J. J., Park, J. S., Shafer, M. M., Deminter, J. T., Weinstein, J. P., 2005. Emissions of metals associated with motor vehicle roadways. Environ. Sci. Technol. 39 (3), 826-836. https://doi.org/10.1021/es048715f.
Maeng, J.-Y., Park, D., Kim, Y.-H., Hwang, J., Kim, Y.-J., 2007. Micromachined cascade virtual impactor for aerodynamic size classification of airborne particles. In: IEEE 20th International Conference on Micro Electro Mechanical Systems (MEMS). https://doi.org/10.1109/MEMSYS.2007.4433121.
Marple, V. A., Liu, B. Y. H., Burton, R. M., 1990a. High-volume impactor for sampling fine and coarse particles. J. Air Waste Manag. Assoc. 40 (5), 762-767. https://doi.org/10.1080/10473289.1990.10466722.
Marple, V. A., Olson, B. A., Santhanakrishnan, K., Roberts, D. L., Mitchell, J. P., Hudsoncurtis, B. L., 2004. Next Generation Pharmaceutical Impactor: A New Impactor for Pharmaceutical Inhaler Testing. Part III. Extension of Archival Calibration to 15 L/min. J. Aerosol Med. 17 (4), 335-343. https://doi.org/10.1089/jam.2004.17.335.
Marple, V. A., Rubow, K. L., Behm, S. M., 1991. A microorifice uniform deposit impactor (MOUDI): description, calibration, and use. Aerosol. Sci. Technol. 14 (4), 434-446. https://doi.org/10.1080/02786829108959504.
Misra, C., Kim, S., Shen, S., Sioutas, C., 2002. A high flow rate, very low pressure drop impactor for inertial separation of ultrafine from accumulation mode particles. J. Aerosol Sci. 33 (5), 735-752. https://doi.org/10.1016/S0021-8502(01)00210-5. Moore, K. F., Ning, Z., Ntziachristos, L., Schauer, J. J., Sioutas, C., 2007. Daily variation in the properties of urban ultrafine aerosol-Part I: physical characterization and volatility. Atmos. Environ. 41 (38), 8633-8646. https:/doi.org/10.1016/j. atmosenv.2007.07.030.
Nelin, T. D., Joseph, A. M., Gorr, M. W., Wold, L. E., 2012. Direct and indirect effects of particulate matter on the cardiovascular system. Toxicol. Lett. 208 (3), 293-299. https://doi.org/10.1016/j.toxlet.2011.11.008.
Ning, Z., Geller, M. D., Moore, K. F., Sheesley, R., Schauer, J. J., Sioutas, C., 2007. Daily variation in chemical characteristics of urban ultrafine aerosols and inference of their sources. Environ. Sci. Technol. 41 (17), 6000-6006. https://doi.org/10.1021/es070653g.
Ning, Z., Moore, K. F., Polidori, A., Sioutas, C., 2006. Field validation of the new miniature versatile aerosol concentration enrichment system (mVACES). Aerosol. Sci. Technol. 40 (12), 1098-1110. https://doi.org/10.1080/02786820600996422.
Patel, P., Aggarwal, S. G., Tsai, C.-J., Okuda, T., 2021. Theoretical and field evaluation of a PM2.5 high-volume impactor inlet design. Atmos. Environ. 244, 117811 https://doi.org/10.1016/j.atmosenv.2020.117811.
Pirhadi, M., Mousavi, A., Sioutas, C., 2020a. Evaluation of a high flow rate electrostatic precipitator (ESP) as a particulate matter (PM) collector for toxicity studies. Sci. Total Environ. 739, 140060 https://doi.org/10.1016/j.scitotenv.2020.140060.
Pirhadi, M., Mousavi, A., Taghvaee, S., Shafer, M. M., Sioutas, C., 2020b. Semi-volatile components of PM2.5 in an urban environment: volatility profiles and associated oxidative potential. Atmos. Environ. 223 https://doi.org/10.1016/j. atmosenv.2019.117197.
Polichetti, G., Cocco, S., Spinali, A., Trimarco, V., Nunziata, A., 2009. Effects of particulate matter (PM10, PM2.5 and PM1) on the cardiovascular system. Toxicology 261 (1-2), 1-8. https://doi.org/10.1016/j.tox.2009.04.035.
Saffari, A., Daher, N., Shafer, M. M., Schauer, J. J., Sioutas, C., 2014. Seasonal and spatial variation in dithiothreitol (DTT) activity of quasi-ultrafine particles in the Los Angeles Basin and its association with chemical species. J. Environ. Sci. Health Part A 49 (4), 441-451. https://doi.org/10.1080/10934529.2014.854677.
Sardar, S. B., Fine, P. M., Mayo, P. R., Sioutas, C., 2005. Size-fractionated measurements of ambient ultrafine particle chemical composition in Los Angeles using the NanoMOUDI. Environ. Sci. Technol. 39 (4), 932-944. https://doi.org/10.1021/es049478j.
Schoonen, M. A. A., Cohn, C. A., Roemer, E., Laffers, R., Simon, S. R., O'Riordan, T., 2006. Mineral-induced formation of reactive oxygen species. Rev. Mineral. Geochem. 64 (1), 179-221. https://doi.org/10.2138/rmg.2006.64.7.
Schwarze, P. E., Øvrevik, J., Lag, M., Refsnes, M., Nafstad, P., Hetland, R. B., Dybing, E., 2006. Particulate matter properties and health effects: consistency of epidemiological and toxicological studies. Hum. Exp. Toxicol. 25 (10), 559-579. https://doi.org/10.1177/096032706072520.
Shafer, M. M., Hemming, J. D. C., Antkiewicz, D. S., Schauer, J. J., 2016. Oxidative potential of size-fractionated atmospheric aerosol in urban and rural sites across Europe. Faraday Discuss 189, 381-405. https://doi.org/10.1039/C5FD00196J.
Shima, H., Koike, E., Shinohara, R., Kobayashi, T., 2006. Oxidative ability and toxicity of n-hexane insoluble fraction of diesel exhaust particles. Toxicol. Sci. 91 (1), 218-226. https://doi.org/10.1093/toxsci/kfj119.
Sioutas, C., Koutrakis, P., Burton, R. M., 1994a. Development of a low cutpoint slit virtual impactor for sampling ambient fine particles. J. Aerosol Sci. 25 (7), 1321-1330.
Sioutas, C., Koutrakis, P., Olson, B. A., 1994b. Development and evaluation of a low cutpoint virtual impactor. Aerosol. Sci. Technol. 21 (3), 223-235. https://doi.org/10.1080/02786829408959711.
Soo, J. C., Monaghan, K., Lee, T., Kashon, M., Harper, M., 2016. Air sampling filtration media: collection efficiency for respirable size-selective sampling. Aerosol. Sci. Technol. 50 (1), 76-87. https://doi.org/10.1080/02786826.2015.1128525.
Sugita, K., Kin, Y., Yagishita, M., Ikemori, F., Kumagai, K., Ohara, T., Kinoshita, M., Nishimura, K., Takagi, Y., Nakajima, D., 2019. Evaluation of the genotoxicity of PM2.5 collected by a high-volume air sampler with impactor. Gene Environ. 41 (1), 7. https://doi.org/10.1186/s41021-019-0120-0.
Taghvaee, S., Mousavi, A., Sowlat, M. H., Sioutas, C., 2019. Development of a novel aerosol generation system for conducting inhalation exposures to ambient particulate matter (PM). Sci. Total Environ. 665, 1035-1045. https://doi.org/10.1016/j.scitotenv.2019.02.214.
Valavanidis, A., Fiotakis, K., Vlachogianni, T., 2008. Airborne particulate matter and human health: toxicological assessment and importance of size and composition of particles for oxidative damage and carcinogenic mechanisms. J. Environ. Sci. Health Part C 26 (4), 339-362. https://doi.org/10.1080/10590500802494538.
Varga, B., Kiss, G., Ganszky, I., Gelencs'er, A., Kriv'acsy, Z., 2001. Isolation of watersoluble organic matter from atmospheric aerosol. Talanta 55 (3), 561-572. https://doi.org/10.1016/S0039-9140(01)00446-5.
Wang, D., Pakbin, P., Saffari, A., Shafer, M. M., Schauer, J. J., Sioutas, C., 2013. Development and evaluation of a high-volume Aerosol-into-Liquid collector for fine and ultrafine particulate matter. Aerosol. Sci. Technol. 47 (11), 1226-1238. https://doi.org/10.1080/02786826.2013.830693.
Wang, H., Bhambri, P., Ivey, J., Vehring, R., 2017. Design and pharmaceutical applications of a low-flow-rate single-nozzle impactor. Int. J. Pharm. 533 (1), 14-25. https://doi.org/10.1016/j.ijpharm.2017.09.047.
Wang, Y., Xiong, L., Tang, M., 2017. Toxicity of inhaled particulate matter on the central nervous system: neuroinflammation, neuropsychological effects and neurodegenerative disease. J. Appl. Toxicol. 37 (6), 644-667. https://doi.org/10.1002/jat.3451. 304/1/012014.
Kang, J. S., Lee, K. S., Lee, K. H., Sung, H. J., Kim, S. S., 2012. Characterization of a microscale cascade impactor. Aerosol Sci. Technol. 46 (9), 966-972. https://doi.org/10.1080/02786826.2012.685115.
Karthikeyan, S., Balasubramanian, R., 2006. Determination of water-soluble inorganic and organic species in atmospheric fine particulate matter. Microchem. J. 82 (1), 49-55. https://doi.org/10.1016/j.microc.2005.07.003.
Kavouras, I. G., Ferguson, S. T., Wolfson, J. M., Koutrakis, P., 2000. Development and validation of a high-volume, low-cutoff inertial impactor. Inhal. Toxicol. 12 (Suppl. 2), 35-50. https://doi.org/10.1080/08958378.2000.11463198.
Kavouras, I. G., Koutrakis, P., 2001. Use of polyurethane foam as the impaction substrate/collection medium in conventional inertial impactors. Aerosol. Sci. Technol. 34 (1), 46-56. https://doi.org/10.1080/02786820118288.
Kim, S., Chang, M.-C., Kim, D., Sioutas, C., 2000. A new generation of portable coarse, fine, and ultrafine particle concentrators for use in inhalation toxicology. Inhal.

What is claimed is:

1. A cascade impactor system comprising cascade impactor, the cascade impactor comprising:
a first impaction stage in fluid communication with ambient air, the first impaction stage including a first slit and a first impaction substrate onto which air impact such that particles within a first particle size range are collected;
a second impaction stage in fluid communication with the first impaction stage, the second impaction stage including one or more second slits and a second impaction substrate onto which air impacts such that particles within a second particle size range are collected, wherein the area of the first slit is greater than the total area of the one or more second slits such that the first particle size range is greater than the second particle size range; and
a pump in fluid communication with the first impaction stage and second impaction stage.

2. The cascade impactor system of claim 1 wherein an average particle size collected by the first impaction substrate is greater than an average particle size collected by the second impaction substrate.

3. The cascade impactor system of claim 1 wherein physical characteristics of the first impaction stage and the second impaction stage are optimized with the Stokes equation.

4. The cascade impactor system of claim 3, configured to have a flow rate of 100 lpm or greater therethrough.

5. The cascade impactor system of claim 1 wherein the first impaction stage has a cut-point diameter greater than that of the second impaction stage.

6. The cascade impactor system of claim 1 further including one or more additional impactor stages upstream of the first impaction stage and one or more additional impactor stages downstream of the second impaction stage.

7. The cascade impactor system of claim 1 further including an upstream impaction stage configured to collect coarse particles having an average size greater than particles collected in the first impaction stage.

8. The cascade impactor system of claim 1 further including a downstream impaction stage configured to collect finer particles than collected in second impaction stage.

9. The cascade impactor system of claim 8 further including a filter downstream of the downstream impaction stage.

10. The cascade impactor system of claim 1, wherein the first impaction substrate and the second impaction substrate are composed of a material that is soluble in water thereby allowing analysis of collected particles.

11. The cascade impactor system of claim 1, wherein the first impaction substrate and the second impaction substrate are composed of gelatin.

12. The cascade impactor system of claim 1, wherein the area of the first slit 16 is 2 to 8 times greater than the total area of the one or more second slits 20.

13. The cascade impactor system of claim 1, wherein the first impaction stage has a cut-point diameter from about 1.5 μm to 5 μm and the second impaction stage has a cut-point diameter from about from about 0.1 to 0.5 μm.

14. A cascade impactor system comprising cascade impactor, the cascade impactor comprising:
a first impaction stage in fluid communication with ambient air, the first impaction stage including a first slit and a first impaction substrate onto which air impact such that particles within a first particle size range are collected;
a second impaction stage in fluid communication with the first impaction stage, the second impaction stage including one or more second slits and a second impaction substrate onto which air impacts such that particles within a second particle size range are collected, wherein the area of the first slit is greater than the total area of the one or more second slits such that the first particle size range is greater than the second particle size range; and
a pump in fluid communication with the first impaction stage and second impaction stage, wherein the first impaction substrate and the second impaction substrate are composed of a water-soluble material.

15. The cascade impactor system of claim 14, wherein an average particle size collected by the first impaction substrate is greater than an average particle size collected by the second impaction substrate.

16. The cascade impactor system of claim 14, wherein physical characteristics of the first impaction stage and the second impaction stage are optimized with the Stokes equation.

17. The cascade impactor system of claim 14, wherein the first impaction stage has a cut-point diameter greater than that of the second impaction stage.

18. The cascade impactor system of claim 14 further including one or more additional impactor stages upstream of the first impaction stage and one or more additional impactor stages downstream of the second impaction stage.

19. The cascade impactor system of claim 14, wherein the first impaction substrate and the second impaction substrate are composed of gelatin.

20. The cascade impactor system of claim 14, wherein the area of the first slit 16 is 2 to 8 times greater than the total area of the one or more second slits 20.

21. The cascade impactor system of claim 14, wherein the first impaction stage has a cut-point diameter from about 1.5 μm to 5 μm and the second impaction stage has a cut-point diameter from about from about 0.1 to 0.5 μm.
